(19) United States
(12) Patent Application Publication
(10) Pub. No.: US 2025/0335589 A1
(43) Pub. Date: Oct. 30, 2025

(54) INTERMITTENT ENCRYPTION ATTACK DETECTION BASED ON ACCUMULATION OF MODIFIED DATA FRAGMENTS

(71) Applicant: Hewlett Packard Enterprise Development LP, Spring, TX (US)

(72) Inventors: Viswesvaran Janakiraman, San Jose, CA (US); Anoop Kumar Raveendran, Bangalore (IN); Rachit Gupta, Bangalore (IN); Jothivelavan Sivashanmugam, Bangalore (IN)

(21) Appl. No.: 18/784,694

(22) Filed: Jul. 25, 2024

(30) Foreign Application Priority Data
Apr. 25, 2024 (IN) 202411032971

(51) Int. Cl. G06F 21/56; G06F 3/06

(52) U.S. Cl. CPC G06F 21/565; G06F 3/0656

(57) ABSTRACT

In some examples, a system identifies data fragments of a data object that are modified relative to a different version of the data object. The system accumulates the data fragments into a buffer, and computes a measure based on data in the buffer, the data comprising the data fragments. The system determines, based on the measure, whether the data object is a subject of an intermittent encryption attack.

### BACKGROUND

A ransomware attack involves encrypting data on a computer or on multiple computers connected over a network. In a ransomware attack, data can be encrypted using an encryption key, which renders the data inaccessible to users unless a ransom is paid to obtain the encryption key. A ransomware attack can be highly disruptive to enterprises, including businesses, government agencies, educational organizations, individuals, and so forth.

### BRIEF DESCRIPTION OF THE DRAWINGS

Some implementations of the present disclosure are described with respect to the following figures.

FIG. 1 is a block diagram of a computer system including an intermittent encryption attack detection engine according to some examples.

FIG. 2 is a block diagram showing different versions of a file, according to some examples.

FIG. 3A and FIG. 3B are block diagrams depicting a value calculator that computes a set of values based on data portions of a first version of a data object in a sliding window, according to some examples.

FIG. 4A and FIG. 4B are block diagrams depicting a value calculator that computes values based on data portions of a second version of the data object in a sliding window, according to some examples.

FIG. 4C is a block diagram showing successive sliding windows, according to some examples.

FIG. 5 is a flow diagram of a process of a modified data fragments detector, according to some examples.

FIG. 6 is a block diagram of an accumulator buffer and an encryption detection window that covers a data segment in the accumulator buffer, according to some examples.

FIG. 7 is a block diagram of a storage medium storing machine-readable instructions according to some examples.

FIG. 8 is a block diagram of a system according to some examples.

FIG. 9 is a flow diagram of a process according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

A ransomware attack can be difficult to detect. By the time a user (e.g., an individual human user, an organization such as a business, a government, or an educational organization, or any other type of entity) becomes aware of the attack, most or all of the data may have been encrypted and thus inaccessible. An inability to detect a ransomware attack in real time may reduce a user's ability to recover from the attack.

In some cases, ransomware can encrypt an entire data object, where a “data object” can refer to any or some combination of the following: a file of a filesystem, an image, a video, an executable program code, or any other container of data. In other cases, ransomware can perform intermittent encryption of a data object, in which the ransomware encrypts selected portions of the data object but not other portions of the data object. Although ransomware protection systems may be able to detect ransomware that encrypts entire data objects, such ransomware protection systems may not work against ransomware that applies intermittent encryption. The intermittent encryption can encrypt small fragments (e.g., 16-byte fragments or other small fragments) of a data object at random locations of the data object. As a result, a ransomware attack based on applying intermittent encryption may escape detection. Any partially encrypted (intermittently encrypted) data objects may be lost since a user may not be able to recover original data from the partially encrypted data objects.

In accordance with some implementations of the present disclosure, an intermittent encryption attack detector is able to determine whether an intermittent encryption attack is present based on collecting fragments of a data object that have been modified relative to a different version (e.g., a prior version or a later version) of the data object. The collected fragments are accumulated into an accumulator buffer having a size that is greater than a size threshold. For example, the accumulator buffer may have a size that is greater than 2 kilobytes (kB) or some other size threshold. The intermittent encryption attack detector applies an encryption detection technique (or multiple different encryption detection techniques) to the data in the accumulator buffer. The accumulator buffer effectively concentrates modified fragments of the data object so that the applied encryption detection technique(s) can effectively detect intermittent encryption of the data object.

An encryption detection technique computes a measure of randomness of the data in the accumulator buffer for determining whether the data in the accumulator buffer has been encrypted. For example, the encryption detection technique can calculate an entropy based on the data in the accumulator buffer. In some examples, the entropy calculated can include Shannon entropy, which measures the uncertainty of a random process. In other examples, an encryption detection technique can apply a Chi-Square test, a National Institute of Standards and Technology (NIST) Cumulative Sums (CUMSUM) test, serial correlation, a Monte Carlo estimation, or any computation that quantifies randomness of data or otherwise indicates that encryption has occurred. In further examples, multiple different encryption detection techniques can be applied on the data accumulated in the accumulator buffer. By concentrating or accumulating modified data fragments of a data object into the accumulator buffer having a size greater than the size threshold, a sufficient amount of data is collected against which randomness-based encryption detection techniques can be applied.

An “accumulator buffer” (or more simply a “buffer”) can refer to any storage resource that can be used to store data. For example, the buffer can be implemented using one or more memory devices (or portions of one or more memory devices), register(s), or other types of storage elements.

An “encryption attack” refers to one or more data encryption operations that are not authorized. During normal operations in the computer system, data encryption may be performed to protect the data against unauthorized access. Such data encryption operations associated with planned or programmed operations are considered authorized data encryption operations. However, unauthorized data encryption operations may be performed by an attacker, including a human user, a program, or a machine.

An example of an encryption attack is performed by ransomware, which includes malware that has been launched in a system to perform encryption of data. The entity that initiated the ransomware attack typically attempts to extract payments (the ransom) from a victim of the ransomware attack, in exchange for an encryption key that can be used by the victim to decrypt the encrypted data. In other examples, encryption attacks may be performed in other contexts by attackers.

An intermittent encryption attack refers to an encryption attack in which less than the entirety of a data object is encrypted. The intermittent encryption attack seeks to encrypt one or more sub-portions of the data object, while leaving remaining sub-portions of the data object unencrypted. A “sub-portion” of the data object refers to a part of the data object, where the part has a size less than the total size of the data object.

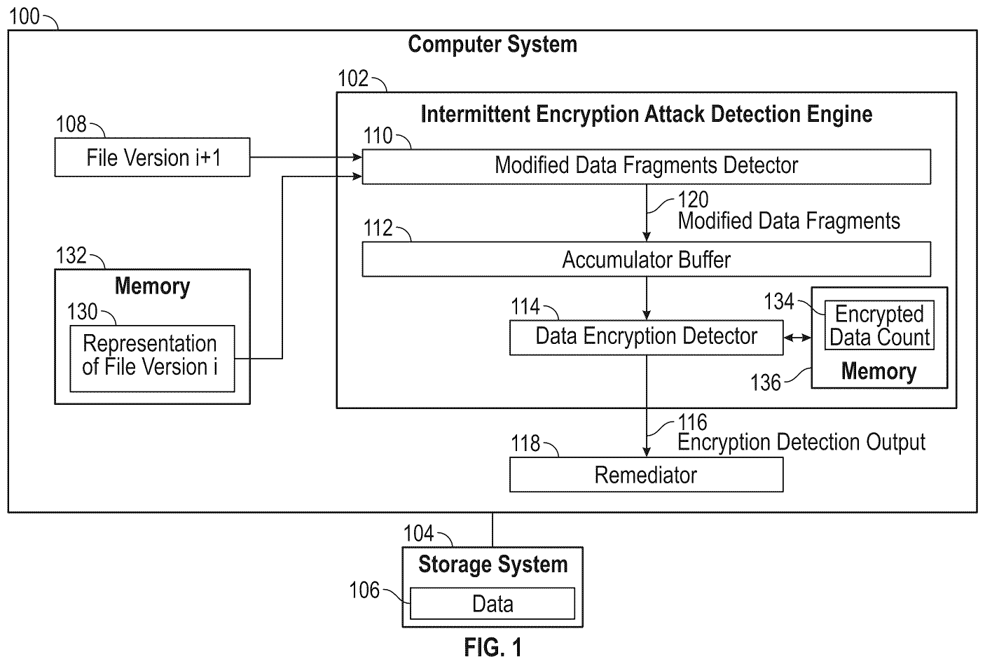

FIG. 1 is a block diagram of a computer system 100 that includes an intermittent encryption attack detection engine 102. An “engine” can be implemented with one or more hardware processing circuits, which can include any or some combination of a microprocessor, a core of a multi-core microprocessor, a microcontroller, a programmable integrated circuit, a programmable gate array, or another hardware processing circuit. Alternatively, an “engine” can be implemented with a combination of one or more hardware processing circuits and machine-readable instructions (software and/or firmware) executable on the one or more hardware processing circuits.

Examples of the computer system 100 can include any or some combination of the following: a collection of computers (e.g., server computers, desktop computers, notebook computers, tablet computers, or other types of computers), a collection of smartphones, a collection of Internet of Things (IoT) devices, a collection of household appliances, a collection of vehicles, a collection of game appliances, or a collection of other types of electronic devices. As used here, a “collection” of items can refer to a single item or multiple items.

A storage system 104 is coupled to the computer system 100. The storage system 104 may be inside the computer system 100, or alternatively, the storage system 104 may be outside the computer system 100. The storage system 104 can be implemented using a collection of storage devices. Examples of storage devices can include any or some combination of the following: disk-based storage devices, solid state drives, or other types of storage devices.

Data 106 can be stored in the storage system 104. In some examples, the data 106 stored in the storage system 104 can include files, such as files of a filesystem. In other examples, the data 106 can include other types of data objects. Although some examples of the present disclosure refer to detecting intermittent encryption attacks on files, in other examples, similar techniques or mechanisms can be used for detecting intermittent encryption attacks on other types of data objects.

In the example of FIG. 1, the intermittent encryption attack detection engine 102 receives a file 108, which in the example is version i+1 of the file (hereinafter referred to as “file version i+1”). In the ensuing discussion, a file version of a file refers to the file containing content at a given point in time. Write operations may cause the content of the file to change. The write of the file can thus cause a new version of the file to be produced. Thus, file version i+1 is a newer version of the file as compared to file version i.

To determine whether an intermittent encryption attack is present, the intermittent encryption attack detection engine 102 receives as input the following: (1) file version i+1 (108) and (2) a representation 130 of file version i. The representation 130 of file version i can include file version i itself, or a set of hash values derived from portions of file version i. Based on file version i+1 and the representation 130 of file version i, the intermittent encryption attack detection engine 102 makes a determination of whether an intermittent encryption attack is present (i.e., has occurred or is occurring).

The intermittent encryption attack detection engine 102 includes a modified data fragments detector 110, an accumulator buffer 112, and a data encryption detector 114. The modified data fragments detector 110 and the data encryption detector 114 can be implemented using a portion of the hardware processing circuitry of the intermittent encryption attack detection engine 102, or can be implemented as machine-readable instructions executed by a processing resource of the intermittent encryption attack detection engine 102. A “processing resource” can refer to one or more processors. A processor can include a microprocessor, a core of a multi-core microprocessor, a microcontroller, a programmable integrated circuit, a programmable gate array, or another hardware processing circuit.

The accumulator buffer 112 can be implemented using a storage resource of the intermittent encryption attack detection engine 102, or using a storage resource that is external to the intermittent encryption attack detection engine 102. The modified data fragments detector 110 determines, based on file version i+1 and the representation 130 of file version i, which data fragments of file version i+1 have been modified relative to the file version i.

The representation 130 of file version i is stored in a memory 132 of the computer system 100. The memory 132 can be implemented using one or more memory devices, such as any or some combination of the following: dynamic random access memory (DRAM) devices, static random access memory (SRAM) devices, flash memory devices, or other types of memory or storage devices.

The representation 130 of file version i includes a set of values. In some examples, the set of values includes data portions of file version i. In such examples, a “value” in the set of values includes a collection of bytes (e.g., 1 byte or multiple bytes) of file version i. In other examples, the set of values includes a set of hash values produced based on applying a function on respective data portions of file version i. The function applied can include a cryptographic hash function or another type of function. A “hash function” produces a value of a fixed length based on input data. A “hash value” in the set of hash values is produced by applying the function on a respective data portion (e.g., a collection of bytes) of file version i.

In some examples, the modified data fragments detector 110 can compare a set of values representing file version i+1 to the set of values representing file version i. This comparison allows the modified data fragments detector 110 to determine which data portions of file version i+1 are modified relative to file version i. The data portions of file version i+1 determined by the modified data fragments detector 110 to have been modified relative to file version i are output by the modified data fragments detector 110 as modified data fragments 120.

Any modified data fragments 120 are added by the modified data fragments detector 110 to the accumulator buffer 112. Data fragments of file version i+1 that are not modified are not added to the accumulator buffer 112. In the accumulator buffer 112, a new modified data fragment 120 can be appended to any previous modified data fragment(s) already in the accumulator buffer 112.

Once the accumulator buffer 112 is filled, the data encryption detector 114 can apply a collection of encryption detection techniques (N encryption detection techniques, where N≥1) to data in the accumulator buffer 112, to determine whether the data in the accumulator buffer 112 has been encrypted. The accumulator buffer 112 being “filled” can refer to the entirety of the accumulator buffer 112 being filled, or to some specified portion (e.g., percentage) of the accumulator buffer 112 being filled with data. Examples of encryption detection techniques include any or some combination of the following: an encryption detection technique that computes a Shannon entropy, an encryption technique that applies a Chi-Square test, an encryption detection technique that applies a CUMSUM test, an encryption detection technique based on serial correlation, an encryption detection technique that applies a Monte Carlo estimation, or any other encryption detection technique.

In examples where multiple encryption detection techniques are applied by the data encryption detector 114, the data encryption detector 114 considers the output of each encryption detection technique to determine whether the data in the accumulator buffer 112 has been encrypted. An encryption detection technique can indicate that data has been encrypted if a measure produced by the encryption detection technique has a value that falls within a specified range (e.g., the measure has a value that exceeds a threshold or is below the threshold). If the value of the measure produced by the encryption detection technique does not fall within the specified range, then the encryption detection technique can indicate that the data has not been encrypted.

In some cases, multiple encryption detection techniques may produce inconsistent results. For example, a first encryption detection technique may indicate that the data in the accumulator buffer 112 has been encrypted, while a second encryption detection technique may indicate that the data in the accumulator buffer 112 has not been encrypted. If an odd number of encryption detection techniques are applied by the data encryption detector 114, then the data encryption detector 114 can indicate that the data in the accumulator buffer 112 has been encrypted if a majority of the encryption detection techniques indicate that the data in the accumulator buffer 112 has been encrypted. For example, if three encryption detection techniques are used, the data encryption detector 114 would indicate that the data in the accumulator buffer 112 has been encrypted if at least two of the three encryption detection techniques indicate data encryption has occurred. In other examples where an even number of encryption detection techniques are used, the data encryption detector 114 can apply different weights to the different encryption detection techniques. In such examples, the result of a first encryption detection technique may be weighted more than the result of a second encryption detection technique. The determination of whether or not the data in the accumulator buffer 112 is encrypted can thus be based on a weighted aggregation of the results from the different encryption detection techniques.

The data encryption detector 114 updates an encrypted data count 134 stored in a memory 136 in response to the data encryption detector 114 determining each instance of data in the accumulator buffer 112 being encrypted. The memory 136 may be the same as or different from the memory 132.

In some examples, the encrypted data count 134 can be an encrypted data bytes count, which counts how many bytes of file version i have been encrypted. Note that file version i+1 in some cases may be much larger than the accumulator buffer 112. As a result, the data encryption detection performed by the data encryption detector 114 is based on segments of file version i+1 (where the segments contain modified data fragments) added to the accumulator buffer 112. After a segment of file version i+1 in the accumulator buffer 112 has been processed by the data encryption detector 114, the segment can be removed from the accumulator buffer 112 and a new segment (containing modified data fragments) of file version i+1 is added to the accumulator buffer 112 for processing by the data encryption detector 114. The successive processing of segments of file version i+1 in the accumulator buffer 112 by the data encryption detector 114 causes the encrypted data count 134 to be incrementally updated. With an update of the encrypted data count 134, the data encryption detector 114 can compute what percentage of file version i+1 has been encrypted. This percentage is based on the ratio of the encrypted data count 134 relative to the total size of file version i+1. If this percentage exceeds a percentage threshold (e.g., 5%, 10%, or any other percentage), then the data encryption detector 114 can make a determination that file version i+1 has been intermittently encrypted. However, if the percentage of file version i+1 been encrypted is less than the percentage threshold, then the data encryption detector 114 does not indicate that file version i+1 has been intermittently encrypted. More generally, the data encryption detector 114 indicates that file version i+1 is intermittently encrypted if the data encryption detector 114 determines that more than some threshold amount of file version i+1 has been encrypted.

The data encryption detector 114 produces an encryption detection output 116, which can include an indicator representing whether file version i+1 has been intermittently encrypted. The indicator can include an information element (e.g., a flag, a field, etc.) that can be set to different values. A first value of the indicator can specify that file version i+1 has been intermittently encrypted, and a different second value of the indicator can specify that file version i+1 has not been intermittently encrypted. The encryption detection output 116 can also include a value (e.g., a percentage value) representing how much of file version i+1 has been intermittently encrypted.

If the data encryption detector 114 determines based on the latest segment of file version i+1 in the accumulator buffer 112 that the percentage of file version i+1 being encrypted exceeds the percentage threshold, then the data encryption detector 114 can generate the encryption detection output 116 indicating that intermittent encryption has been detected, without having to process the remainder of file version i+1.

The encryption detection output 116 can be provided to a remediator 118 in the computer system 100. In other examples, the remediator 118 can be external to the computer system 100. The remediator 118 may be implemented using one or more hardware processing circuits, or machine-readable instructions executed on one or more hardware processing circuits. The remediator 118 can take one or more remediation actions in response to the encryption detection output 116 indicating that file version i+1 has been encrypted.

The remediation actions taken by the remediator 118 can include any or some combination of the following: providing an alert of an encryption attack, disabling components of the computer system 100 (e.g., stopping programs, shutting down electronic components, disabling network access, etc.), disabling the entire computer system 100 (e.g., placing the computer system 100 in a lower power state such as a sleep state or a power off state), or any other remediation action.

In examples in which the remediator 118 is outside the computer system 100, the computer system 100 can send, such as in a message or an information element, the encryption detection output 116 to the remediator 118, such as over a network.

By concentrating modified data fragments into the accumulator buffer 112, encryption detection techniques can more reliably detect encryption of the data in the buffer as compared to attempting to detect encryption in an intermittently encrypted file.

In some examples, the intermittent encryption attack detection engine 102 can be used for intermittent encryption detection for selected files (or more generally data objects). For example, a user or another entity may select more important files that are subject to protection by the intermittent encryption attack detection engine 102. Such “more important” files can include files containing sensitive or confidential data, for example. Also, some files may be encrypted during normal operations. A user or another entity can provide hints regarding which files are expected to be encrypted, so that the intermittent encryption attack detection engine 102 would not be applied to such files. If a file is not expected to be encrypted, then the intermittent encryption attack detection engine 102 would be able to reach a high confidence in identifying the file as being the subject of an intermittent encryption attack more quickly (e.g., without having to consider the whole file when a portion of the file is detected as encrypted).

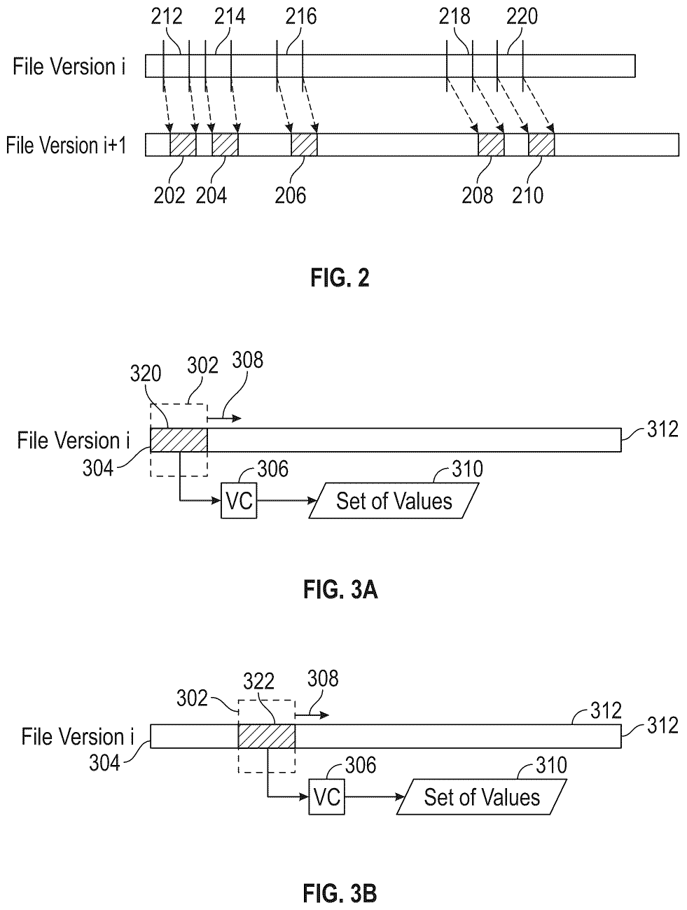

FIG. 2 illustrates an example of file version i and file version i+1. In file version i+1, data fragments 202, 204, 206, 208, and 210 have been modified relative to respective data fragments 212, 214, 216, 218, and 220 of file version i. One or more of the modified data fragments 202, 204, 206, 208, and 210 of file version i+1 may be produced by encryption of the respective data fragments 212, 214, 216, 218, and 220 of file version i. The remaining portions of file version i+1 (other than data fragments 202, 204, 206, 208, and 210) have not been modified relative to file version i. The modified data fragments detector 110 is able to determine, based on file version i+1 and the representation 130 of file version i which data fragments of file version i+1 have been modified relative to respective data fragments of file version i.

FIG. 3A and FIG. 3B show an example of how the representation 130 of file version i (FIG. 1) can be produced based on file version i. In the example of FIGS. 3A and 3B, the representation 130 of file version i includes a set of values 310.

FIG. 3A shows a sliding window 302 in which the start of the sliding window 302 is positioned at the beginning 304 of file version i. The sliding window 302 has a specified small window size, such as 4 to 8 bytes (or some other window size). In some examples, the window size of the sliding window 302 can be tuned. A smaller window size may increase the concentration of modified data fragments in the accumulator buffer 112, but results in increased processing resource usage. A larger window size may decrease the concentration of modified data fragments in the accumulator buffer 112, but uses less processing resource. The smaller window size can increase the reliability of encryption detection, but performance can suffer if the processing resource is overloaded. The selection of the window size can be based on experimentation or based on detected results during use of the intermittent encryption attack detection engine 102.

A data portion 320 of file version i in the sliding window 302 is provided to a value calculator (VC) 306, which calculates a value to add to the set of values 310 based on the data portion 320 in the sliding window 302. The VC 306 may be part of the intermittent encryption attack detection engine 102, or may be outside of the intermittent encryption attack detection engine 102. For example, the VC 306 may include a hardware accelerator to compute a value based on a data portion of file version i. In other examples, the VC 306 may be implemented using machine-readable instructions.

Note that the set of values 310 may be initially empty when the sliding window 302 is at its initial position as shown in FIG. 3A. The value based on the data portion 320 in the sliding window 302 calculated by the VC 306 can be just the bits (or bytes) of the data portion 320 itself, or alternatively, the value based on the data portion 320 in the sliding window 302 is calculated by the VC 306 by applying a function (e.g., a hash function) to the data portion 320. The value calculated by the VC 306 is added to the set of values 310.

In the example of FIGS. 3A-3B, the sliding window 302 is moved from left to right in direction 308 (from the beginning 304 of file version i to the end 312 of file version i). In other examples, the sliding window 302 may be moved in the opposite direction, from the end 312 of file version i to the beginning 304 of file version i.

With each iteration, the sliding window 302 is advanced by a specified sliding increment. For example, the sliding window 302 may be advanced by M bytes (M≥1) for each iteration of calculating a value based on a respective data portion of file version i. After the sliding window 302 has been moved to the position shown in FIG. 3B, a data portion 322 in the sliding window 302 is provided to the VC 306, which calculates a value based on the data portion 322. The value is added to the set of values 310.

The multiple iterations of the VC 306 for different positions of the sliding window 302 produce respective values that are added to the set of values 310. The set of values 310 includes respective values corresponding to different positions of the sliding window 302 (and respective different data portions of file version i). Indexes can be used to represent the different positions of the sliding window 302 (and thus the different data portions of file version i). The values in the set of values 310 can be associated with respective indexes.

In some examples, the values of the set of values 310 may be calculated in parallel by multiple instances of the VC 306. For example, multiple hardware accelerators or multiple instances of the machine-readable instructions of the VC 306 can be used to calculate in parallel values for different positions of the sliding window 302. The multiple instances of the VC 306 can add the respective values to the set of values 310. Calculating the set of values 310 in parallel can improve the performance and speed of the intermittent encryption attack detection engine 102.

Once the set of values 310 is derived based on file version i, the set of values 310 can be used by the modified data fragments detector 110 to detect modified data fragments in file version i+1.

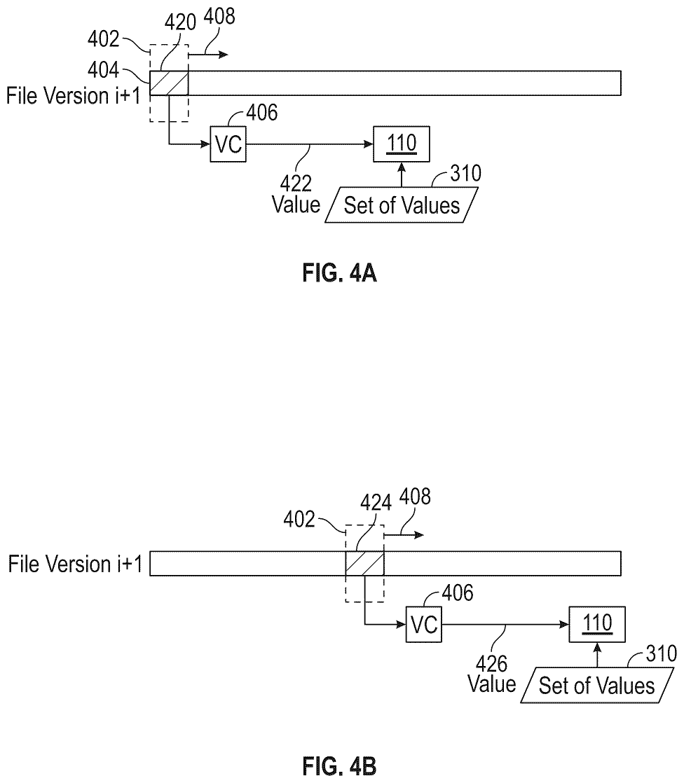

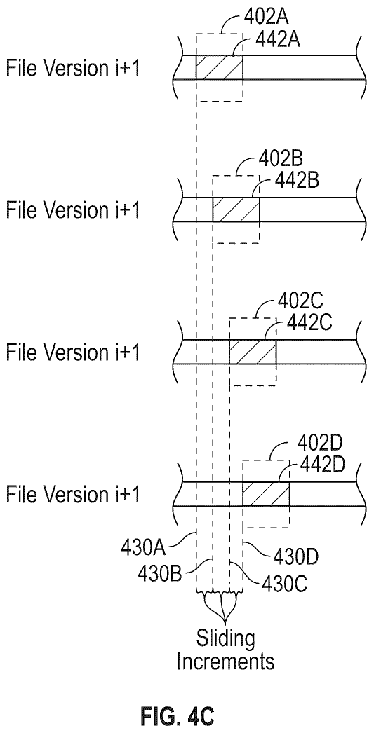

FIG. 4A and FIG. 4B show an example of how the modified data fragments detector 110 detects modified data fragments in file version i+1. A sliding window 402 (of the same window size as the sliding window 302 of FIGS. 3A and 3B) can be moved across file version i+1 in direction 408, for example.

FIG. 4A shows the sliding window 402 at its initial position relative to file version i+1, in which the start of the sliding window 402 is positioned at the beginning 404 of file version i+1. A data portion 420 of file version i+1 in the sliding window 402 is provided to a VC 406, which calculates a value 422 based on the data portion 420 in the sliding window 402. The VC 406 performs the same calculation as the VC 306 of FIGS. 3A and 3B.

The value 422 is associated with a first index corresponding to the initial position of the sliding window 402. The value 422 is compared to a first comparison value from the set of values 310, where the first comparison value in the set of values 310 is associated with the first index corresponding to the initial position of the sliding window 402. If the value 422 matches the first comparison value, then the modified data fragments detector 110 makes a determination that the data portion 420 is not a modified data fragment. However, if the value 422 does not match the first comparison value, then the modified data fragments detector 110 makes a determination that the data portion 420 is a modified data fragment.

FIG. 4B shows the sliding window 402 at a different position relative to file version i+1. A data portion 424 of file version i+1 in the sliding window 402 at the position shown in FIG. 4B is provided to the VC 406, which calculates a value 426 based on the data portion 424 in the sliding window 402.

The value 426 is associated with a second index corresponding to the position of the sliding window 402 of FIG. 4B. The value 426 is compared to a second comparison value from the set of values 310, where the second comparison value in the set of values 310 is associated with the second index corresponding to the position of the sliding window 402 of FIG. 4B. If the value 426 matches the second comparison value, then the modified data fragments detector 110 makes a determination that the data portion 424 is not a modified data fragment. However, if the value 426 does not match the second comparison value, then the modified data fragments detector 110 makes a determination that the data portion 424 is a modified data fragment.

The advancement of the sliding window 402 in successive iterations of the modified data fragments detector 110 for detecting modified data fragments can be by the same sliding increment as used for the sliding window 302 of FIGS. 3A and 3B. For example, the sliding window 402 may be advanced by M bytes (M≥1).

To increase the likelihood that data fragments added to the accumulator buffer 112 include modified data (and correspondingly to decrease the likelihood that data fragments added to the accumulator buffer 112 include unmodified data), a data fragment identified as modified by the modified data fragments detector 110 includes data from a subset of windows in which modified data fragments are detected. FIG. 4C shows four different positions of the sliding window 402 of FIGS. 4A and 4B. A first sliding window at a first position is represented as 402A, a second sliding window at a second position is represented as 402B, a third sliding window at a third position is represented as 402C, and a fourth sliding window at a fourth position is represented as 402D.

The four sliding windows together make up a run of sliding windows. Stated differently, the run of sliding windows covers multiple consecutive positions of a given sliding window relative to a file.

The start of the first sliding window 402A begins at position 430A. The second sliding window 402B is offset by the sliding increment relative to the sliding window 402A. The start of the second sliding window 402B begins at position 430B. The third sliding window 402C is offset by the sliding increment relative to the sliding window 402B. The start of the third sliding window 402C begins at position 430C. The fourth sliding window 402D is offset by the sliding increment relative to the sliding window 402C. The start of the fourth sliding window 402D begins at position 430D. Thus, the run of sliding windows shown in FIG. 4C includes four sliding windows 402A to 402D that are successively offset relative to one another by the sliding increment. In other words, the sliding window 402B is offset relative to the sliding window 402A by the sliding increment, the sliding window 402C is offset relative to the sliding window 402B by the sliding increment, and the sliding window 402D is offset relative to the sliding window 402C by the sliding increment.

More generally, a run of sliding windows can include P (P>1) sliding windows that are successively offset from one another by the sliding increment; in other words, in the run of P sliding windows, a second sliding window is offset from a first sliding window by the sliding increment, a third sliding window is offset from the second sliding window by the sliding increment, and so forth.

The first sliding window 402A contains a data fragment 442A that was detected by the modified data fragments detector 110 as modified, and the fourth sliding window 402D contains a data fragment 442D that was detected by the modified data fragments detector 110 as modified. Note that the modified data fragments detector 110 can assume that inner data fragments 442B and 442C are modified since they are between the first and last data fragments 442A and 442D of the run that were detected as modified. As a result, the modified data fragments detector 110 does not have to separately make a comparison of the values corresponding to the inner data fragments 442B and 442C to respective values of the set of values 310 representing file version i. Skipping the comparison for the inner data fragments 442B and 442C reduces workload and improves the efficiency of the modified data fragments detector 110.

Although all four data fragments 442A to 442D were determined as modified data fragments, the modified data fragments detector 110 does not add all four data fragments 442A to 442D to the accumulator buffer 112. Instead, the modified data fragments detector 110 selects a subset of the data fragments 442A to 442D to add to the accumulator buffer 112. For example, the modified data fragments detector 110 selects the inner data fragments 442B and 442C (covered by respective inner sliding windows 402B and 402C) to add to the accumulator buffer 112. The modified data fragments detector 110 does not add outer data fragments 442A and 442D (covered by respective outer sliding windows 402A and 402D) to the accumulator buffer 112.

More generally, from among P sliding windows in a run that contain modified data fragments, the modified data fragments detector 110 selects data fragments from a subset of P sliding windows to add to the accumulator buffer 112. For example, the selected subset of sliding windows includes the inner sliding windows of the run, and the selected subset of sliding windows excludes the outer sliding windows of the run, such as the first sliding window of the run and the last sliding window of the run.

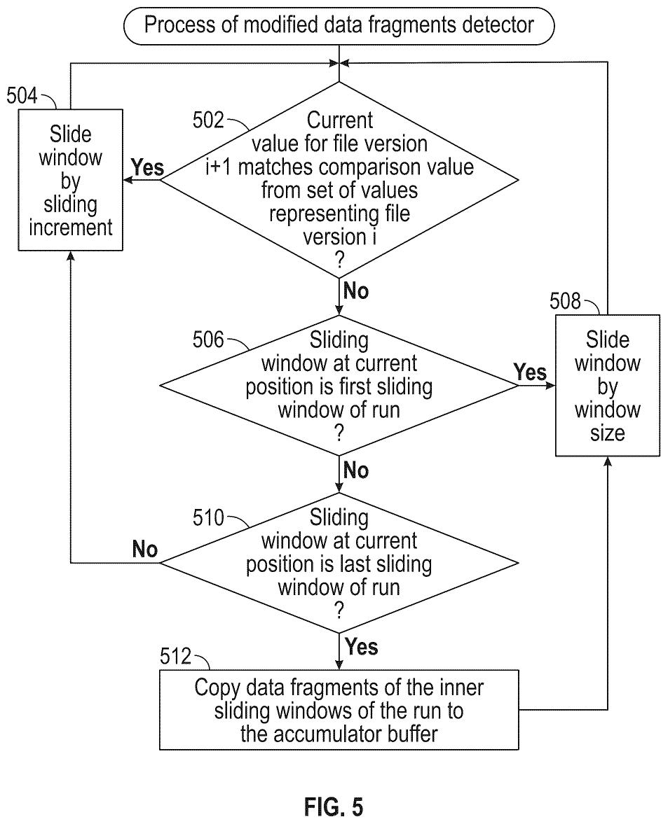

FIG. 5 is a flow diagram of a process of the modified data fragments detector 110. For a current position of the sliding window 402 relative to file version i+1, the modified data fragments detector 110 compares (at 502) a current value for the data portion in the sliding window 402 at the current position to a respective comparison value in the set of values 310 representing file version i. If the current value matches the respective comparison value, the modified data fragments detector 110 slide (at 504) the sliding window 402 by the sliding increment, and proceeds back to task 502.

However, if the current value does not match the respective comparison value, then that indicates that the data portion in the sliding window 402 at the current position is a modified data fragment. In response to determining that the current value does not match the respective comparison value, the modified data fragments detector 110 determines (at 506) whether the sliding window at the current position is the first sliding window of the run. In response to determining that the sliding window at the current position is the first sliding window of the run, the modified data fragments detector 110 slides (at 508) the sliding window 402 by the window size (rather than just the sliding increment). For example, the sliding increment may be 1 byte, while the window size may be 4 bytes. Sliding the sliding window 402 by the window size refers to sliding the sliding window 402 by 4 bytes in this example.

If the sliding window at the current position is the first sliding window of the run, then sliding the sliding window by the window size would skip the comparisons for the inner data fragments covered by the inner sliding windows of the run.

After sliding (at 508) the sliding window 402 by the window size, the modified data fragments detector 110 returns to perform tasks 502, 504, and 506. The modified data fragments detector 110 determines (at 510) whether the sliding window at the current position is the last sliding window of the run. If not, the modified data fragments detector 110 slides (at 504) the sliding window by the sliding increment, and proceeds back to task 502.

In response to determining that the sliding window at the current position is the last sliding window of the run, the modified data fragments detector 110 copies (at 512) the data fragments of the inner sliding windows to the accumulator buffer 112. The modified data fragments detector 110 then slides (at 508) the sliding window by the window size, and proceeds back to task 502 for the next run.

When the accumulator buffer 112 is filled, the data encryption detector 114 applies a collection of encryption detection techniques (a single encryption technique or multiple encryption techniques) to a data segment in the accumulator buffer 112. For example, the data segment in the accumulator buffer 112 on which the data encryption detector 114 applies the collection of encryption detection techniques can have a size of 512 bytes, or some other size, such as 1 kB, 2 KB, and so forth, up to the total size of the accumulator buffer 112.

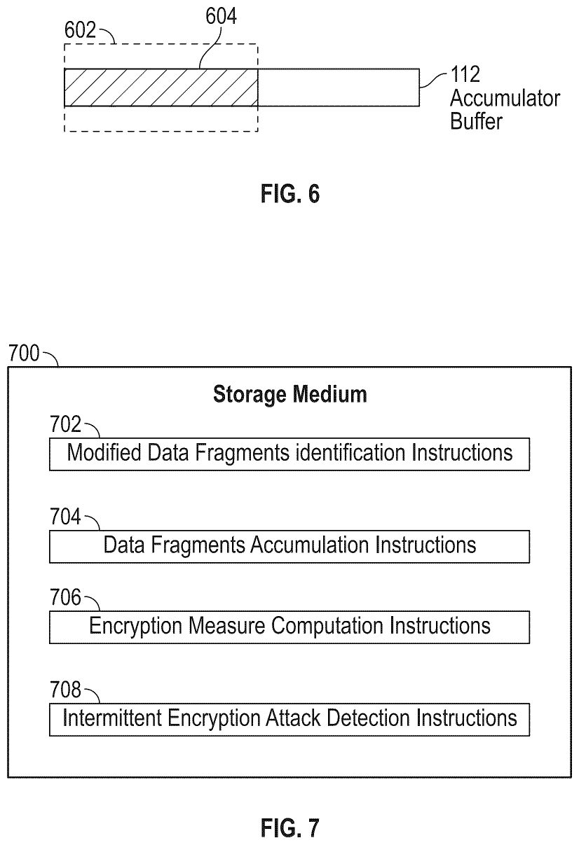

As shown in FIG. 6, an encryption detection window 602 covers a data segment 604 in the accumulator buffer 112. The encryption detection window 602 can span less than the entirety of the accumulator buffer 112 (in the example shown in FIG. 6), or alternatively, the encryption detection window 602 can span the entirety of the accumulator buffer 112.

The data encryption detector 114 applies the collection of encryption detection techniques to the data segment 604 defined by the encryption detection window 602. When data encryption is detected with high confidence (e.g., two or more encryption detection techniques indicate data encryption has occurred or, alternatively, an encryption detection technique outputs a measure with a value exceeding a threshold indicating that data encryption has been detected), the data encryption detector 114 can indicate that the data in the data segment 604 has been encrypted. The data encryption detector 114 can update the encrypted data count 134 (e.g., increment the encrypted data count 134 by a number of bytes). If the data segment 604 is not encrypted, the data encryption detector 114 does not update the encrypted data count 134.

After the application of the collection of encryption detection techniques to the data segment 604, the data encryption detector 114 can shift the position of the encryption detection window 602 to cover another data segment in the accumulator buffer 112. The data encryption detector 114 can then determine whether the data segment covered by the shifted encryption detection window 602 is encrypted.

When the data encryption detector 114 reaches the last data segment in the accumulator buffer 112, the data encryption detector 114 can shift the encryption detection window 602 to the beginning of the accumulator buffer 112. Note that after data encryption detection has been applied to a given data segment in the current position of the encryption detection window 602, the data segment can be removed from the accumulator buffer 112 so that additional modified data fragments can be added by the modified data fragments detector 110 to the vacated part of the accumulator buffer 112. In this way, the accumulator buffer 112 can be continually populated with modified data fragments while the data encryption detector 114 determines whether any of the data segments in the accumulator buffer 112 covered by the encryption detection window 602 has been encrypted.

As noted above, if the data encryption detector 114 determines that more than some threshold amount of file version i+1 has been encrypted (based on a ratio of the encrypted data count 134 relative to the total size of file version i+1, for example), then the data encryption detector 114 can stop the encryption detection process and can mark file version i+1 as encrypted.

The data encryption detector 114 can then proceed to process another file. Being able to stop the encryption detection process early if a threshold amount of a file is determined to be encrypted can allow the encryption detection of files to proceed more quickly.

FIG. 7 is a block diagram of a non-transitory machine-readable or computer-readable storage medium 700 storing machine-readable instructions that upon execution cause a system to perform various tasks. The system can include one or more computers.

The machine-readable instructions include modified data fragments identification instructions 702 to identify data fragments of a data object that are modified relative to a different version of the data object. In some examples, the different version of the data object is represented by a set of values (e.g., 310 in FIGS. 3A and 3B). The modified data fragments identification instructions 702 can compare values derived from data portions of the data object to respective values in the set of values. In some examples, a given data fragment of the data object is identified as modified relative to a respective data fragment of the different version of the data object based on the comparing indicating that a first value derived based on a first portion of the data object is different from a second value corresponding to a respective portion of the different version of the data object.

The machine-readable instructions include data fragments accumulation instructions 704 to accumulate the data fragments into a buffer. The data fragments accumulated into the buffer are modified data fragments. Data fragments not identified as modified are not added to the buffer. In some examples, the buffer includes the accumulator buffer 112 of FIG. 1.

The machine-readable encryption measure computation instructions 706 to compute a measure based on data in the buffer, the data including the modified data fragments. The measure is produced by applying one or more encryption detection techniques to the data in the buffer. The measure can include one or more measures of randomness produced by the one or more encryption detection techniques.

The machine-readable instructions include intermittent encryption attack determination instructions 708 to determine, based on the measure, whether the data object is a subject of an intermittent encryption attack. The intermittent encryption attack is indicated if greater than some threshold amount of the data object is encrypted.

In some examples, values in a set of values representing the different version of the object are obtained by a value calculator, which can be implemented using hardware or using machine-readable instructions. The values in the set of values can be obtained in parallel using a plurality of instances of the value calculator.

In some examples, identifying the data fragments of the data object that are modified relative to the different version of the data object includes deriving first values based on a data portion of the data object covered by a window of a specified size.

In some examples, the window is a sliding window that is moved with respect to the data object to obtain data portions of the data object on which the first values are derived.

In some examples, the measure is computed based on a data segment in the buffer within an encryption detection window of a specified size. In some examples, the encryption detection window has a size that is less than a size of the buffer.

In some examples, the machine-readable instructions can shift the encryption detection window across data segments in the buffer, and can compute respective measures based on the data segments covered by the encryption detection window at different positions. The determining of whether the data object is the subject of the intermittent encryption attack is based on the respective measures.

In some examples, the machine-readable instructions can determine whether greater than a threshold amount of the data object based on processing modified data fragments accumulated in the buffer is encrypted. The machine-readable instructions can indicate that the data object is the subject of the intermittent encryption attack responsive to a determination that greater than the threshold amount of the data object is encrypted.

In some examples, the machine-readable instructions can move a sliding window relative to the data object. The identifying of the data fragments of the data object that are modified includes performing a run that covers a plurality of consecutive positions of the sliding window, the plurality of consecutive positions of the sliding window including the sliding window at a first position in the run and the sliding window at a last position in the run. Accumulating the data fragments into the buffer includes adding, to the buffer, data fragments covered by the sliding windows at intermediate positions between the first position and the last position, and declining to add data fragments covered by the sliding windows at the first position and the last position to the buffer.

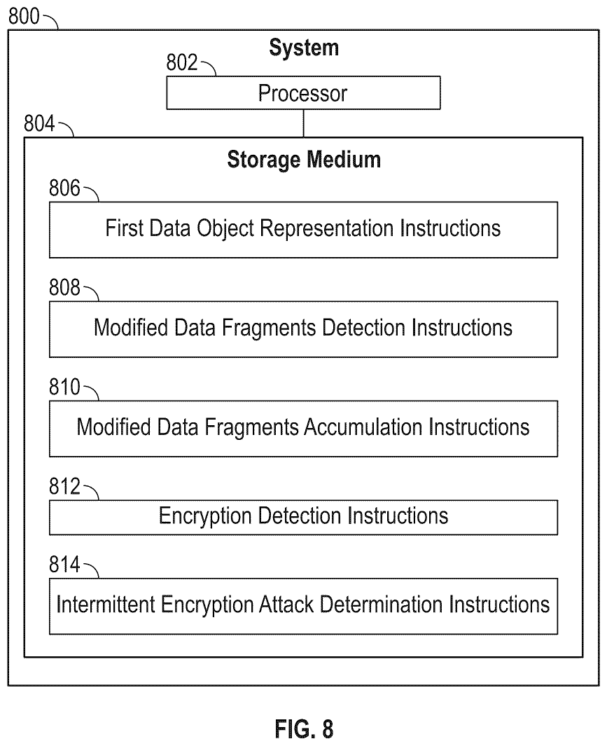

FIG. 8 is a block diagram of a system 800, which may include one or more computers. The system 800 includes a processor 802 (or multiple processors). The system 800 includes a storage medium 804 storing machine-readable instructions executable on the processor 802 to perform various tasks. Machine-readable instructions executable on a processor can refer to the instructions executable on a single processor or the instructions executable on multiple processors.

The machine-readable instructions in the storage medium 804 include first data object representation instructions 806 to compute a set of values representing a first version of a data object. The values of the set of values can include respective data portions of the first version of the data object, or hash values derived from applying hash functions to the respective data portions of the first version of the data object.

The machine-readable instructions in the storage medium 804 include modified data fragments detection instructions 808 to detect modified data fragments by comparing values based on data portions of a second version of the data object to respective values in the set of values. In some examples, the values for the second version of the data object are derived by sliding a window across the second version of the data object. The first set of values are derived by sliding a window across the first version of the data object.

The machine-readable instructions in the storage medium 804 include modified data fragments accumulation instructions 810 to accumulate the modified data fragments into a buffer.

The machine-readable instructions in the storage medium 804 include encryption detection instructions 812 to apply an encryption detection technique to data in the buffer. In some cases, multiple encryption detection techniques can be applied to the data in the buffer.

The machine-readable instructions in the storage medium 804 include intermittent encryption attack determination instructions 814 to determine, based on the application of the encryption detection technique to the data in the buffer, whether the data object is a subject of an intermittent encryption attack.

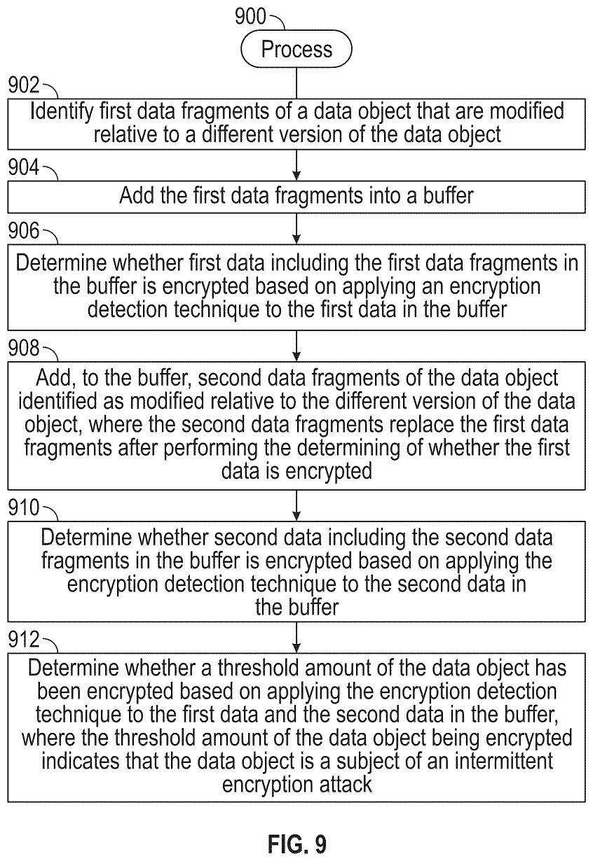

FIG. 9 is a flow diagram of a process 900 according to some examples of the present disclosure. The process 900 can be performed by the intermittent encryption attack detection engine 102 of FIG. 1, for example.

The process 900 includes identifying (at 902) first data fragments of a data object that are modified relative to a different version of the data object. The identifying of modified data fragments includes comparing values derived from data portions of the data object to respective values in a set of values representing the different version of the data object.

The process 900 includes adding (at 904) the first data fragments into a buffer. The process 900 includes determining (at 906) whether first data including the first data fragments in the buffer is encrypted based on applying an encryption detection technique to the first data in the buffer. The encryption detection technique produces a measure that indicates whether the first data is likely encrypted.

The process 900 includes adding (at 908), to the buffer, second data fragments of the data object identified as modified relative to the different version of the data object, where the second data fragments replace the first data fragments after performing the determining of whether the first data is encrypted. As data in the buffer is processed, the data can be removed and further data fragments can be added to the buffer.

The process 900 includes determining (at 910) whether second data including the second data fragments in the buffer is encrypted based on applying the encryption detection technique to the second data in the buffer.

The process 900 includes determining (at 912) whether a threshold amount of the data object has been encrypted based on applying the encryption detection technique to the first data and the second data in the buffer, where the threshold amount of the data object being encrypted indicates that the data object is a subject of an intermittent encryption attack.

A storage medium (e.g., 700 in FIG. 7 or 804 in FIG. 8) can include any or some combination of the following: a semiconductor memory device such as a DRAM or SRAM, an erasable and programmable read-only memory (EPROM), an electrically erasable and programmable read-only memory (EEPROM) and flash memory; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the present disclosure, use of the term “a,” “an,” or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A non-transitory machine-readable storage medium comprising instructions that upon execution cause a system to:
identify data fragments of a data object that are modified relative to a different version of the data object;
accumulate the data fragments into a buffer;
compute a measure based on data in the buffer, the data comprising the data fragments; and
determine, based on the measure, whether the data object is a subject of an intermittent encryption attack.

2. The non-transitory machine-readable storage medium of claim 1, wherein the buffer has a size greater than a size threshold, and wherein the instructions upon execution cause the system to:
detect that the data has filled the buffer,
wherein the computing of the measure is performed responsive to the data filling the buffer.

3. The non-transitory machine-readable storage medium of claim 1, wherein the identifying of the data fragments of the data object that are modified relative to the different version of the data object comprises:
comparing first values derived based on portions of the data object to respective second values based on portions of the different version of the data object.

4. The non-transitory machine-readable storage medium of claim 3, wherein the instructions upon execution cause the system to:
obtain the second values in parallel using a plurality of instances of a value calculator that calculates the second values based on the portions of the different version of the data object.

5. The non-transitory machine-readable storage medium of claim 3, wherein the identifying of the data fragments of the data object that are modified relative to the different version of the data object comprises:
deriving the first values based on data in a window of a specified size.

6. The non-transitory machine-readable storage medium of claim 5, wherein the window is a sliding window that is moved with respect to the data object to obtain the portions of the data object on which the first values are derived.

7. The non-transitory machine-readable storage medium of claim 3, wherein the first values comprise the portions of the data object.

8. The non-transitory machine-readable storage medium of claim 3, wherein the first values are derived based on applying a function on the portions of the data object.

9. The non-transitory machine-readable storage medium of claim 3, wherein the instructions upon execution cause the system to:
identify a given data fragment of the data object as modified relative to a respective data fragment of the different version of the data object based on the comparing indicating that a first value derived based on a first portion of the data object is different from a second value corresponding to a respective portion of the different version of the data object.

10. The non-transitory machine-readable storage medium of claim 1, wherein the measure is computed based on a data segment in the buffer within an encryption detection window of a specified size.

11. The non-transitory machine-readable storage medium of claim 10, wherein the encryption detection window has a size that is less than a size of the buffer.

12. The non-transitory machine-readable storage medium of claim 10, wherein the instructions upon execution cause the system to:
shift the encryption detection window across data segments in the buffer; and
compute respective measures based on the data segments covered by the encryption detection window at different positions,
wherein the determining of whether the data object is the subject of the intermittent encryption attack is based on the respective measures.

13. The non-transitory machine-readable storage medium of claim 12, wherein the instructions upon execution cause the system to:
determine whether greater than a threshold amount of the data object based on processing modified data fragments accumulated in the buffer is encrypted; and
indicate that the data object is the subject of the intermittent encryption attack responsive to a determination that greater than the threshold amount of the data object is encrypted.

14. The non-transitory machine-readable storage medium of claim 1, wherein the measure is a first measure derived using a first encryption detection technique, and the instructions upon execution cause the system to:
compute a second measure based on the data in the buffer using a second encryption detection technique different from the first encryption detection technique,
wherein the determining of whether the data object is the subject of the intermittent encryption attack is based on the first measure and the second measure.

15. The non-transitory machine-readable storage medium of claim 1, wherein the instructions upon execution cause the system to:
move a sliding window relative to the data object,
wherein the identifying of the data fragments of the data object that are modified comprises:
performing a run that covers a plurality of consecutive positions of the sliding window, the plurality of consecutive positions of the sliding window comprising the sliding window at a first position in the run and the sliding window at a last position in the run, and
wherein the accumulating of the data fragments into the buffer comprises:
adding, to the buffer, data fragments covered by the sliding windows at intermediate positions between the first position and the last position, and
declining to add data fragments covered by the sliding windows at the first position and the last position to the buffer.

16. A system comprising:
a processor; and
a non-transitory storage medium comprising instructions executable on the processor to:
compute a set of values representing a first version of a data object;
detect modified data fragments by comparing values based on data portions of a second version of the data object to respective values in the set of values;
accumulate the modified data fragments into a buffer;
apply an encryption detection technique to data in the buffer; and
determine, based on the application of the encryption detection technique to the data in the buffer, whether the data object is a subject of an intermittent encryption attack.

17. The system of claim 16, wherein the instructions executable on the processor to:
apply a plurality of encryption detection techniques to the data in the buffer,
wherein the determining of whether the data object is the subject of the intermittent encryption attack is based on the application of the plurality of encryption detection techniques to the data in the buffer.

18. The system of claim 16, wherein the instructions executable on the processor to:
compute the set of values representing the first version of the data object by:
sliding a first window relative to the first version of the data object, and
deriving the values of the set of values based on data portions covered by the first window at different positions relative to the first version of the data object;
slide a second window relative to the second version of the data object;
derive a value for the second version of the data object based on a data portion in the second window; and
compare the derived value for the second version of the data object to a respective value in the set of values representing the first version of the data object.

19. A method comprising:
identifying, by a system comprising a hardware processor, first data fragments of a data object that are modified relative to a different version of the data object;
adding, by the system, the first data fragments into a buffer;
determining, by the system, whether first data comprising the first data fragments in the buffer is encrypted based on applying an encryption detection technique to the first data in the buffer;
adding, by the system to the buffer, second data fragments of the data object identified as modified relative to the different version of the data object, wherein the second data fragments replace the first data fragments after performing the determining of whether the first data is encrypted;
determining, by the system, whether second data comprising the second data fragments in the buffer is encrypted based on applying the encryption detection technique to the second data in the buffer; and
determining, by the system, whether a threshold amount of the data object has been encrypted based on applying the encryption detection technique to the first data and the second data in the buffer, wherein the threshold amount of the data object being encrypted indicates that the data object is a subject of an intermittent encryption attack.

20. The method of claim 19, wherein the identifying of the first data fragments of the data object that are modified relative to the different version of the data object comprises:
comparing values derived from data portions of the data object to values of a set of values representing the different version of the data object,
wherein a mismatch of a value derived from a data portion of the data object to a value in the set of value indicates a modified data fragment.
